(19) United States
(12) Patent Application Publication
(10) Pub. No.: US 2006/0240256 A1
(43) Pub. Date: Oct. 26, 2006

(54) Nano-structured metal-carbon composite and process for preparation thereof

(75) Inventors: Seong Ihl Woo, Seoul (KR); Won Choon Choi, Daejoon (KR)

Correspondence Address: MERCHANT & GOULD PC, P.O. BOX 2903, MINNEAPOLIS, MN, 55402-0903, US

(73) Assignee: Korea Advanced Institute of Science and Technology, Daejeon (KR)

(21) Appl. No.: 10/553,271

(22) PCT Filed: Apr. 16, 2004
(86) PCT No.: PCT/KR04/00887

§ 371 Date: Oct. 12, 2005

(30) Foreign Application Priority Data
Apr. 17, 2003 (KR) 1020030024319
Aug. 23, 2003 (KR) 1020030058480

(51) Int. Cl. D01D 5/40; B32B 5/16

(52) U.S. Cl. 428/402; 977/810; 264/140

(57) ABSTRACT

Disclosed are a nano-structured metal-carbon composite and a process for preparation thereof. More specifically, a nano-structured metal-carbon composite is prepared by continuously impregnating a transition metal precursor and a carbon precursor into a nano template and reacting the resultant mixture at high temperature. In the composite according to the present invention, metal is regularly multi-dispersed in a size of less than 1 nano meter, and metal and carbon are chemically bonded, thereby exhibiting the highly excellent hydrogen storage capacity.

### TECHNICAL FIELD

The present invention generally relates to a nano-structured metal-carbon composite and a method for preparation thereof, and more specifically, to a nano-structured metal-carbon composite having excellent hydrogen storage capacity and a process for preparing a nano-structured metal-carbon composite obtained by preparing a nano template, successively impregnating a metal precursor and a carbon precursor in the nano template and reacting the resultant structure.

### BACKGROUND OF THE INVENTION

Unlike generally well-known amorphous carbon, carbon nano-tube or lamellar carbon has been known to have a hydrogen storage capacity. The hydrogen storage capacity of the carbon increases in proportion to the surface area of the carbon and the volume of pores. Since this characteristic appears only at a low temperature up to a usual temperature of liquid nitrogen (−196° C.), it is difficult to use the hydrogen storage capacity commercially. However, a carbon nano-tube or a carbon nano-fiber shows excellent hydrogen storage capacity with relatively smaller surface area and smaller pores volume.

To improve the hydrogen storage capacity, various metals are introduced to a carbon nano-tube. For example, a carbon nano-tube introduced with an alkali metal such as lithium has a higher hydrogen storage capacity than a common carbon nano-tube. This carbon nano-tube has been known to store hydrogen present in an amount ranging from about 14 to 20 wt % based on the 100 wt % carbon nano-tube at a temperature ranging from 200 to 400° C. or at room temperature and atmospheric pressure. Furthermore, a storage and emission cycle of hydrogen can be repeated without degrading the storage capacity. Primary material of the carbon nano-tube is methane, and the carbon nano-tube has a specific lamellar structure having an open edge effective for hydrogen adsorption. The alkali metal added to here serves as a catalyst in hydrogen adsorption.

The carbon of specific structure such as fullerene or carbon nano-tube may exhibit characteristics of conductors or semiconductors due to introduction of various metals. Since physical or chemical characteristics of hydrogen adsorption are changed, introduction of transition metals such as Pt to the above-structured carbon is meaningful.

However, much cost is required for mass production of fullerene or carbon nano-tube with high purity, and it is very difficult to change an electronic structure of the carbon by introducing the transition metal to the carbon structure.

Since the carbon is a very stable material, a true nano-structured composite having a chemical bond of metal-carbon and a method for preparation thereof have scarcely been known. As a conventional process for preparing a nano-structured composite, a process for preparing and thermally treating an organic metal precursor such as (PPh₃)₂Pt(C₂H₄) has been known (JACS 1992, 114, 769). However, there is a disadvantage of preparation or purchase of an expensive precursor such as (PPh₃)₂Pt(C₂H₄) in the above conventional method. Further, it has not been known that the nano-structured metal-carbon composite prepared by the above conventional method comprises a chemical bond of Pt—C.

### BRIEF DESCRIPTION OF THE DRAWINGS

FIG. 1 is a structural analysis result of a nano-structured metal-carbon composite obtained from Example 1.

FIG. 2 is a XRD analysis result of a nano-structured metal-carbon composite obtained from Example 1.

FIG. 3 is a pore structure analysis result of a nano-structured metal-carbon composite obtained from Example 1.

FIG. 4 is an EXAFS analysis result of a nano-structured metal-carbon composite obtained from Example 1.

FIG. 5 is a hydrogen storage isotherm of a nano-structured platinum-carbon composite obtained from Example 1 (hydrogen adsorption-desorption experimental result).

FIG. 6 is a hydrogen storage capacity experimental result of a nano-structured platinum-carbon composite obtained from Example 1.

FIG. 7 is a hydrogen storage isotherm of a nano-structured copper-carbon composite obtained from Example 3 (hydrogen adsorption-desorption experimental result).

FIG. 8 is a hydrogen storage isotherm of a nano-structured nickel-carbon composite obtained from Example 4 (hydrogen adsorption-desorption experimental result).

FIG. 9 is a hydrogen storage isotherm of a nano-structured magnesium-carbon composite obtained from Example 5 (hydrogen adsorption-desorption experimental result).

FIG. 10 is a hydrogen storage isotherm of a nano-structured cobalt-carbon composite obtained from Example 6 (hydrogen adsorption-desorption experimental result).

FIG. 11 is a hydrogen storage capacity experimental result of a conventional carbon nano-tube for hydrogen storage (J. Mat. Chem. 2003, 13, 209).

### DETAILED DESCRIPTION OF THE PREFERRED EMBODIMENTS

### Technical Subject

The object of the present invention is to solve the above-described problems, namely to provide a nano-structured metal-carbon composite which may combine a transition metal such as platinum to a mesoporous carbon having a porous nano-structure other than fullerene or carbon nano-tube in a simple and economical manner, easily change an electronic structure of the carbon and have excellent hydrogen storage capacity at room temperature, and a method for preparation thereof.

### Technical Solution

In order to achieve the above-described object, a nano-structured metal-carbon composite is manufactured using a nano template. Here, the nano template is selected from silica oxide, alumina oxide or mixtures thereof, preferably, a silica oxide.

In the nano-structured metal-carbon composite of the present invention, a carbon precursor of the metal-carbon composite is selected from the group consisting of furfuryl alcohol, glucose and sucrose. Preferably, the carbon precursor is sucrose.

In the nano-structured metal-carbon composite of the present invention, the metal-carbon composite comprises at least one metal selected from the group consisting of Pt, Ru, Cu, Ni, Mg, Co, W, Fe, Ir, Rh, Ag, Au, Os, Cr, Mo, V, Ta, Zr, Hf, Li, Na, K, Be, Ca, Ba, Mn, Pd, Ti, Zn, Al, Ga, Sn, Pb, Sb, Se, Te, Cs, Rb, Sr, Ce, Pr, Nd, Sm, Re and B. Further, the metal precursor is selected from (NH₃)₄Pt(NO₃)₂, (NH₃)₆RuCl₃, CuCl₂, Ni(NO₃)₂, Mg(NO₃)₂, CoCl₂, NH₄)₆W₁₂O₃₉, FeCl₃ or FeCl₃(NH₄)₃, IrCl₆, RhCl₃, AgCl, NH₄AuCl₄, OsCl₃, CrCl₂, MoCl₅, VCl₃, TaCl₅, ZrCl₄, HfCl₄, Li₂CO₃, NaCl, KCl, Be(CH₃COCHCOCH₃)₂, CaCl₂, BaCl₂, MnCl₂, Pd(NO₃)₂, TiCl₄, ZnCl₂, AlCl₃, Ga₂Cl₄, SnCl₄, PbCl₂, SbCl₃, SeCl₄, TeCl₄, CsCl, RbCl, SrCl₂, CeCl₃, PrCl₃, NdCl₃, SmCl₃, ReCl₃ and BCl₃.

In the nano-structured metal-carbon composite of the present invention, the metal is contained in an amount ranging from 1 to 95 wt % and the carbon is contained in an amount ranging from 5 to 99 wt %, based on the gross weight of the metal-carbon composite. Preferably, the metal is contained in an amount ranging from 4 to 36 wt % and the carbon is contained in an amount ranging from 64 to 96 wt %, based on the gross weight of the metal-carbon composite.

In the nano-structured metal-carbon composite of the present invention, the platinum is contained in an amount ranging from 0.2 to 44 wt % and the carbon is contained in an amount ranging from 56 to 99.8 wt %, based on the gross weight of the metal-carbon composite. Preferably, the platinum is contained in an amount ranging from 2 to 34 wt % and the carbon is contained in an amount ranging from 66 to 98 wt %, based on the gross weight of the metal-carbon composite.

In an embodiment, a process for preparing a nano-structured metal-carbon composite comprises:

the preparation step of preparing a nano template;

the calcination step of calcining the prepared nano template;

the impregnation step of impregnating a metal into the calcined nano template using a metal precursor;

the addition and mixing step of adding a carbon precursor in the nano template impregnated with the metal and mixing the carbon precursor uniformly;

the reaction step of reacting the resultant mixture prepared in the addition and mixing step;

the carbonization step of carbonizing the resultant reacted mixture; and

the removal step of removing the nano template from the resultant carbonized mixture.

In the method according to the present invention, the nano template is selected from silica oxide, alumina oxide or mixtures thereof, and preferably, the nano template is a silica oxide.

In the method according to the present invention, the reaction step is performed at a temperature ranging from 100 to 160° C., and the carbonization step is performed at a temperature ranging from 800 to 1000° C.

In the method according to the present invention, the carbon precursor is selected from the group consisting of furfuryl alcohol, glucose and sucrose. Preferably, the carbon precursor is sucrose.

In the method according to the present invention, the metal-carbon composite comprises at least one metal selected from the group consisting of Pt, Ru, Cu, Ni, Mg, Co, W, Fe, Ir, Rh, Ag, Au, Os, Cr, Mo, V, Ta, Zr, Hf, Li, Na, K, Be, Ca, Ba, Mn, Pd, Ti, Zn, Al, Ga, Sn, Pb, Sb, Se, Te, Cs, Rb, Sr, Ce, Pr, Nd, Sm, Re and B, and the metal precursor is selected from (NH₃)₄Pt(NO₃)₂, (NH₃)₆RuCl₃, CuCl₂, Ni(NO₃)₂, Mg(NO₃)₂, CoCl₂, (NH₄)₆W₁₂O₃₉, FeCl₃ or FeCl₃(NH₄)₃, IrCl₆, RhCl₃, AgCl, NH₄AuCl₄, OsCl₃, CrCl₂, MoCl₅, VCl₃, TaCl₅, ZrCl₄, HfCl₄, Li₂CO₃, NaCl, KCl, Be(CH₃COCHCOCH₃)₂, CaCl₂, BaCl₂, MnCl₂, Pd(NO₃)₂, TiCl₄, ZnCl₂, AlCl₃, Ga₂Cl₄, SnCl₄, PbCl₂, SbCl₃, SeCl₄, TeCl₄, CsCl, RbCl, SrCl₂, CeCl₃, PrCl₃, NdCl₃, SmCl₃, ReCl₃ and BCl₃.

The disclosed nano-structured metal-carbon composite according to the present invention is prepared using a nano template. For the nano template used in Examples 1 to 7, SBA-15 of a silica oxide type has been primarily used but MCM-48 of a silica oxide type can be used. Besides, an alumina oxide, mixtures of an alumina oxide and a silica oxide can be used.

Preferably, a carbon precursor of the metal-carbon composite is selected from the group consisting of furfuryl alcohol, glucose and sucrose. More preferably, sucrose is used because a carbon nano array having more perfect structure can be manufactured.

Preferably, the metal-carbon composite comprises at least one metal selected from the group consisting of Pt, Ru, Cu, Ni, Mg, Co, W, Fe, Ir, Rh, Ag, Au, Os, Cr, Mo, V, Ta, Zr, Hf, Li, Na, K, Be, Ca, Ba, Mn, Pd, Ti, Zn, Al, Ga, Sn, Pb, Sb, Se, Te, Cs, Rb, Sr, Ce, Pr, Nd, Sm, Re and B. Here, at least one metal means that one of the above metals can be included or one or more of the above metals can be included. For example, one of platinum and ruthenium or both of Pt—Ru can be impregnated in a nano template using (NH₃)₄Pt(NO₃)₂ and (NH₃)₆RuCl₃ as precursor of platinum and ruthenium, respectively.

In the disclosed nano-structured metal-carbon composite, the metal-carbon composite comprises at least one metal selected from the group consisting of Pt, Ru, Cu, Ni, Mg, Co, W, Fe, Ir, Rh, Ag, Au, Os, Cr, Mo, V, Ta, Zr, Hf, Li, Na, K, Be, Ca, Ba, Mn, Pd, Ti, Zn, Al, Ga, Sn, Pb, Sb, Se, Te, Cs, Rb, Sr, Ce, Pr, Nd, Sm, Re and B. Here, at least one metal is contained in an amount ranging from 1 to 95 wt % and the carbon is contained in an amount ranging from 5 to 99 wt %, based on the gross weight of the metal-carbon composite. For more excellent hydrogen storage capacity, it is preferable that the metal is contained in an amount ranging from 4 to 36 wt % and the carbon is contained in an amount ranging from 64 to 96 wt %, based on the gross weight of the metal-carbon composite.

In the nano-structured metal-carbon composite, the platinum is contained in an amount ranging from 0.2 to 44 wt % and the carbon is contained in an amount ranging from 56 to 99.8 wt %, based on the gross weight of the metal-carbon composite. For more excellent hydrogen storage capacity, it is preferable that the platinum is contained in an amount ranging from 2 to 34 wt % and the carbon is contained in an amount ranging from 66 to 98 wt %, based on the gross weight of the metal-carbon composite.

In the process for preparing the nano-structured metal-carbon composite, the reaction is performed after impregnating a catalyst metal precursor and a carbon precursor continuously in a single reactor of a nano template which is selected from silica oxide, alumina oxide or mixture thereof, so that the process is economical. After the reaction, the resultant mixture is carbonized and then the nano template is removed. As a result, a novel composite having a chemical bond of metal and carbon can be obtained. This composite exhibits excellent hydrogen storage capacity.

As described above, the present inventors prepared a novel composite having a bond of metal of less than 1 nano-meter and carbon by reacting and vacuum-heating a metal precursor and a carbon precursor continuously in a nano template, and confirmed that hydrogen can be stored in ultrafine pores by regulating physical and chemical characteristics of the carbon, thereby completing the present invention. The obtained material may be used for not only hydrogen storage, but also various catalyst reaction and electronic materials depending on kinds of metals.

### Preferred Embodiments

The preferred embodiments of the present invention will be described in detail with reference to the accompanying drawings.

### EXAMPLE 1

A. Preparation of Nano Template (MCM-48)

Pre-heated 1M sodium hydroxide (77.5 g) and Ludox HS 40 (22.5 g) were stirred and mixed at 80° C., and the resultant mixture was used as a silica source (precursor of a nano template). The above prepared silica material, cetyltrimethyl ammonium bromide (CTMABr) and C₁₂EO₄ were mixed to be a gel mixture having a ratio of 5SiO₂:1.25Na₂O:0.85CTMABr:0.15Cl₂EO₄:400H₂O. The resultant gel mixture was first reacted at a 100° C. oven for 60 hours. A small amount of acetic acid was added for the resultant first-reacted mixture to have a pH 10. The resultant mixture was secondly reacted at a 100° C. oven for 40 hours, thereby obtaining a nano template (MCM-48). The above-prepared MCM-48 is described only to disclose a process for preparation, and a nano template SBA-15 described below was used in Examples.

B. Preparation of Nano Template (SBA-15)

Pre-heated hydrochloric acid of 1.6M (380 mL) and Pluronic P123 (10 g) of BASF Co., Ltd. were stirred and mixed at room temperature. Next, tetraethylorthosilicate (TEOS) (22 g) was added to the resultant mixture and stirred. Thereafter, the resultant mixture was polymerized at 80° C. to remove a surfactant, and then used.

C. Preparation of Nano-Structured Pt—C Composite Using Nano Template

After the nano template (SBA-15) obtained from the preparation method B was calcined at 300° C., a Pt precursor solution was added to the nano template so that 67 wt % Pt based on the 1 g of the nano template was impregnated. The resultant mixture was dehydrated with a vacuum drier. Here, (NH₃)₄t(NO₃)₂ was used as a Pt precursor. The impregnation process was to induce the Pt precursor to be uniformly impregnated into the nano template by vacuum-drying the solution including the Pt precursor and the nano template. Thereafter, sucrose (2.5 g), sulphuric acid (0.28 g) and water (10 g) were added to the resultant mixture. Then, the resultant mixture was reacted at 100° C. and 160° C. respectively for 6 hours, and carbonized under a vacuum atmosphere at 900° C. The nano template was melt and removed with diluted fluoric acid aqueous solution, and washed, thereby obtaining a nano-structured Pt—C composite.

### EXAMPLES 2 to 45

### Preparation of Nano-Structured Metal-Carbon Composite Using Nano Template

After the nano template (SBA-15) obtained from Example 1 was calcined at 300° C., a mixture impregnated with 24 wt % Ru, Cu, Ni, Mg, Co and W respectively based on the 1 g of the nano template was prepared using a vacuum drier. For precursors of Ru, Cu, Ni, Mg, Co and W, (NH₃)₆RuCl₃, CuCl₂, Ni(No₃)₂, Mg(NO₃)₂, CoCl₂, (NH₄)₆W₁₂O₃₉ were used respectively. Thereafter, sucrose (2.5 g), sulphuric acid (0.28 g) and water (10 g) were added to the resultant mixture and mixed uniformly. Then, the resultant mixture was reacted at 100° C. and 160° C. respectively for 6 hours, and carbonized under a vacuum atmosphere at 900° C. The nano template was melt and removed with diluted fluoric acid aqueous solution, and washed, thereby a nano-structured ruthenium-carbon composite (Example 2), a copper-carbon composite (Example 3), a nickel-carbon composite (Example 4), a magnesium-carbon composite (Example 5), a cobalt-carbon composite (Example 6) and a tungsten-carbon composite (Example 7).

The following analysis experiment was performed to find the structure of the nano-structured platinum-carbon composite (Example 1) prepared using a nano template.

In order to analyze the structure of the nano-structured platinum-carbon composite, a Transmission Electron Microscope (TEM), a X-ray Diffractometer (XRD), a pore analyzer, an Extended X-ray Absorption Fine Structure (EXAFS) were used.

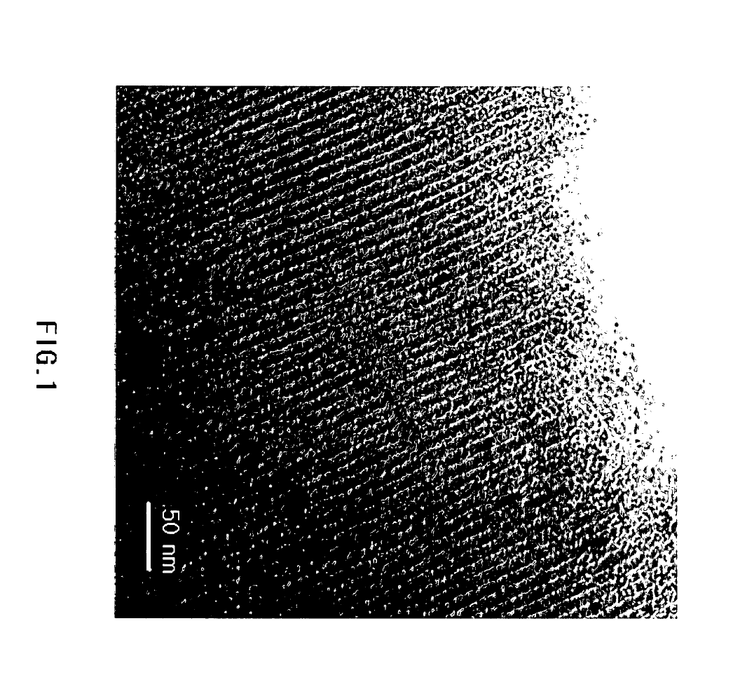

FIG. 1 shows an observation result of the nano-structured platinum-carbon composite obtained from Example 1 using the TEM. As shown in FIG. 1, the disclosed nano-structured metal-carbon composite was observed to have a 3-dimensional structure.

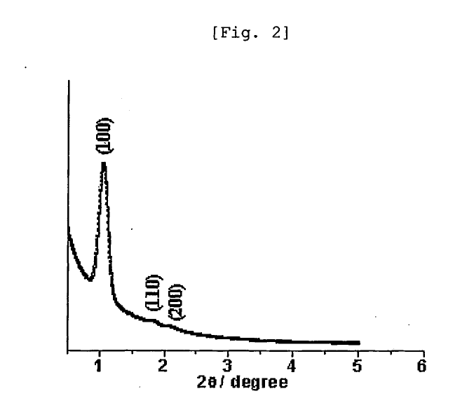

FIG. 2 is a XRD analysis result of the nano-structured platinum-carbon composite obtained from Example 1. Since the XRD analysis result of the disclosed nano-structured metal-carbon composite was the same as that of SBA-15, the disclosed composite was observed to have a replica fabricated as a shape of the nano template. This experimental result supports the fact that the nano-structured platinum-carbon composite has a 3-dimensional structure.

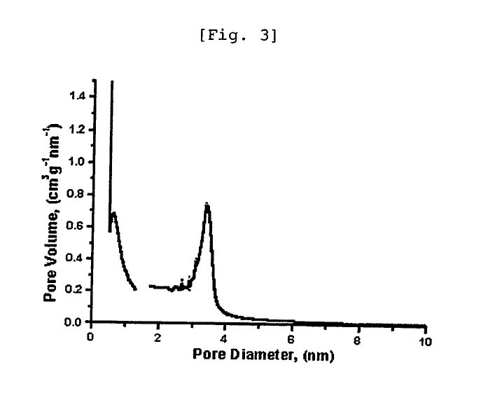

FIG. 3 is a pore structure analysis result of the nano-structured platinum-carbon composite obtained from Example 1. FIG. 3 shows that the disclosed composite has a great deal of fine pores consisting of micro-pores of less than 1 nano-meter and mesopores. As a result of calculation with adsorption isotherm, the BET surface area is observed to be almost 1700 m²/g.

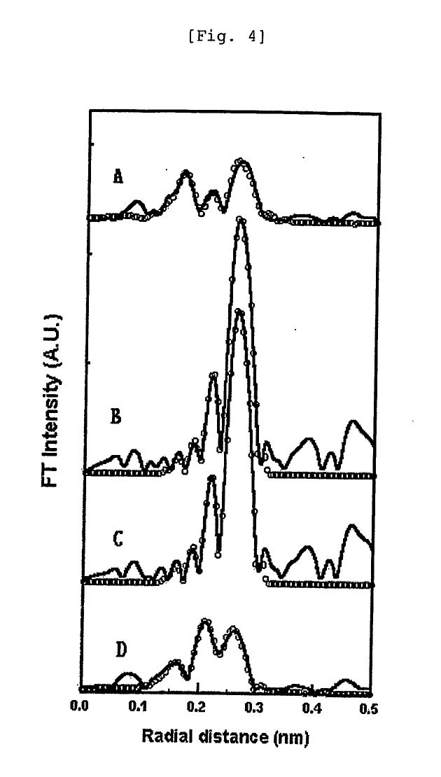

FIG. 4 is an EXAFS analysis result of the nano-structured platinum-carbon composite obtained from Example 1 and an analysis result of the conventional platinum-carbon composite. The curves A and D show a result of the disclosed platinum-carbon composite, and the curves B and C show a result of the conventional composite. Table 1 shows a graph simulation result of EXAFS from the analysis result of FIG. 4.

TABLE 1
Graph simulation result of EXAFS

| | | | | Pt—Pt | Pt—C |
|---|---|---|---|---|---|
| | | Pt—Pt | Pt—C | bond | bond |
| | | bond | bond | length | length |
| | Sample | number | number | (nm) | (nm) |
| A | Nano-structured | 4.31 | 2.73 | 0.2735 | 0.2041 |
| | Pt—C | | | | |
| | Composite (1) | | | | |
| B | Pt/C (1) | 9.58 | | 0.2757 | |
| C | Pt/C (2) | 9.71 | | 0.2757 | |
| D | Nano-structured | 2.78 | 2.12 | 0.2736 | 0.2041 |
| | Pt—C | | | | |
| | Composite (2) | | | | |

As shown in Table 1, the Pt—C bond number and length could be determined in the nano-structured Pt—C composite (1) and the nano-structured Pt—C composite (2) (corresponding to the curves A and D of the analysis result of FIG. 4, respectively) while the Pt—C bond number and length could not be determined in the conventional Pt/C (1) and Pt/C (2) (corresponding to the curves B and C of the analysis result of FIG. 4, respectively). It is clear from the above results that metal and carbon are simply mixed in the conventional composites, while metal and carbon are not simply mixed but platinum of less than 1 nano-meter and carbon are chemically bonded in the disclosed nano-structured Pt—C composite. That is, it is precisely known that the disclosed composite has a novel chemical bond structure even in less than 1 nano meter fine micro-pores. Accordingly, the stable chemical bond of metal and carbon represents a novel characteristic structure of the disclosed nano-structured Pt—C composite.

Although carbon is a stable material in general, the carbon may be used as a useful material if the structural characteristic is changed as shown in the present invention. Since the disclosed nano-structured metal-carbon composite using a nano template may combine various metals chemically, the carbon included in the composite exhibits various characteristics. For example, if some metal is introduced into a catalyst to regulate a band gap, it is probable to generate hydrogen through split of water. Since power consumption can be reduced using a metal-carbon composite having excellent conductibility in a manufacture process of semiconductor elements, the disclosed composite may be used in a fine element process. Furthermore, since carbon can transmit a sensitive electronic reaction if metal is bonded to carbon, the carbon can be used in a fine sensor manufacture.

From the above-described analysis results, the disclosed nano-structured Pt—C composite has a 3-dimensional structure with a nano size, and Pt of less than 1 nano meter is chemically bonded with carbon regularly in a 2 or 3 dimension and multi-dispersed.

The hydrogen adsorption/desorption experiment is performed to find hydrogen storage capacity of the nano-structured metal-carbon composites prepared using the nano template which are obtained from Examples 1 to 7.

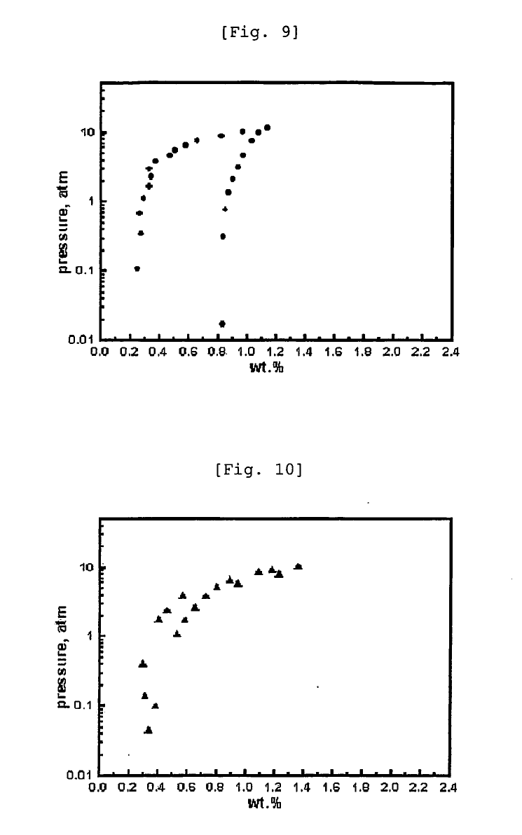

The sample (86.1 mg) was put in a stainless steel reactor, and the residual volume of the reactor was measured. Then, the equilibrium pressure was measured with pressurization of hydrogen. The experiment was performed at room temperature, and the experimental results were shown in FIGS. 5 to 10.

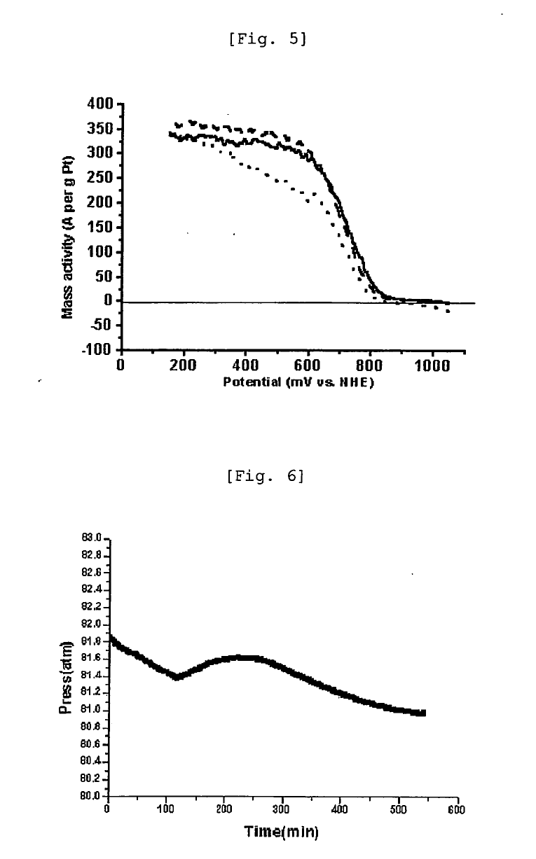

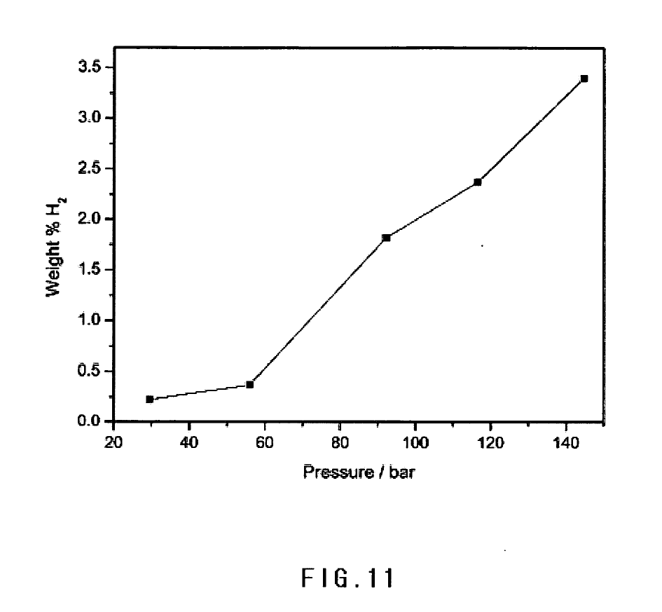

FIG. 5 shows a repeated hydrogen adsorption/desorption result performed at up to 15 atm in the disclosed nano-structured Pt—C composite. FIG. 6 shows a hydrogen adsorption result of the disclosed nano-structured Pt—C composite at 80 atm. FIG. 11 shows an experimental result (J. Mat. Chem. 2003, 13, 209) of the conventional carbon nano-tube to compare hydrogen storage capacity of the disclosed nano-structured Pt—C composite with that of the conventional carbon nano-tube.

As shown in FIG. 11, the conventional carbon nano-tube shows the hydrogen storage capacity of about 0.25 wt % at 30 atm. However, the disclosed nano-structured Pt—C composite shown in FIG. 5 shows the excellent hydrogen storage capacity of about 1.8 wt % at 17 atm (see FIG. 5) and of about 9.8 wt % at 80 atm (see FIG. 6, calculation result by the change of mole numbers of hydrogen adsorbed through pressure change in an equation of state, PV=nRT).

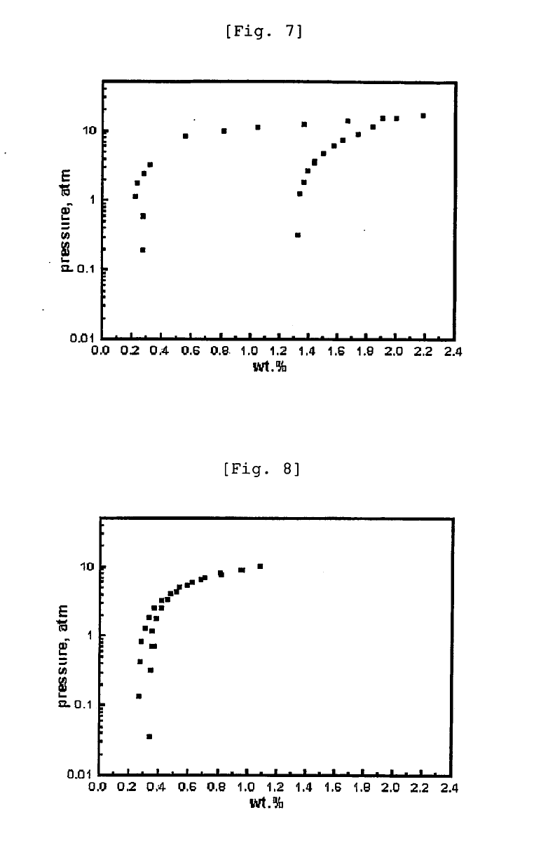

FIGS. 7 to 10 show hydrogen adsorption-desorption experimental results at 10 atm using hydrogen storage isotherms of a copper-carbon composite obtained from Example 3, a nickel-carbon composite obtained from Example 4, a magnesium-carbon composite obtained from Example 5 and a cobalt-carbon composite obtained from Example 6, respectively.

In FIGS. 7 to 10, the copper-carbon composite obtained from Example 3 shows the excellent hydrogen storage capacity of about 0.9 wt %, the nickel-carbon composite obtained from Example 4 shows the excellent hydrogen storage capacity of about 1.05 wt %, the magnesium-carbon composite obtained from Example 5 shows the excellent hydrogen storage capacity of about 1.12 wt %, and the cobalt-carbon composite obtained from Example 6 shows the excellent hydrogen storage capacity of about 1.35 wt %. Although not shown in the drawings, the ruthenium-carbon composite and the tungsten-carbon composite which is obtained from Example 2 and Example 7 respectively show the excellent hydrogen storage capacity of about 1.01% and about 1.43% respectively at 10 atm.

Metal-carbon composites (Examples 8 to 45) were prepared using a nano template in the same manner as that of the Examples 1 to 7 except using precursors such as FeCl₃ or FeCl₃(NH₄)₃, IrCl6, RhCl₃, AgCl, NH₄AuCl₄, OsCl₃, CrCl₂, MoCl₅, VCl₃, TaCl₅, ZrCl₄, HfCl₄, Li₂CO₃, NaCl, KCl, Be(CH₃COCHCOCH₃)₂, CaCl₂, BaCl₂, MnCl₂, Pd(NO₃₎₂, TiCl₄, ZnCl₂, AlCl₃, Ga₂Cl₄, SnCl₄, PbCl₂, SbCl₃, SeCl₄, TeCl₄, CsCl, RbCl, SrCl₂, CeCl₃, PrCl₃, NdCl₃, SmCl₃, ReCl₃ and BCl₃ corresponding to the other metals such as Fe, Ir, Rh, Ag, Au, Os, Cr, Mo, V, Ta, Zr, Hf, Li, Na, K, Be, Ca, Ba, Mn, Pd, Ti, Zn, Al, Ga, Sn, Pb, Sb, Se, Te, Cs, Rb, Sr, Ce, Pr, Nd, Sm, Re and B, thereafter analyzed. As a result, in the obtained metal-carbon composites manufactured by using the nano template including theses metals, it was shown that metal and carbon are chemically bonded and the composites showed the excellent hydrogen storage capacity. Table 2 shows hydrogen storage capacity of the metal-carbon composites obtained from Examples 8 to 45 at hydrogen equilibrium pressure of 10 atm. It should be understood that these results were measured at the hydrogen equilibrium pressure of 10 atm and the hydrogen storage capacity of the metal-carbon composite can be more improved as the hydrogen equilibrium pressure becomes higher. For example, in case of materials exhibiting the conventional hydrogen storage capacity; they have the hydrogen storage capacity of less than 0.1 wt % at 6 MPa (about 59 atm) (‘Hydrogen storage capacity of commercially available carbon materials at room temperature’, H. Kajiura et al., APPLIED PHYSICS LETTERS, 2003. 02. 17, Vol. 82, No. 7). However, it is shown that the disclosed metal-carbon composites have the excellent hydrogen storage capacity even at 10 atm as shown in Table 2. Accordingly, it is understood that the hydrogen storage capacity may become more excellent at a higher pressure.

TABLE 2
Hydrogen storage experimental result of metal-carbon composite
(Examples 8 to 45)

| | Metal of metal-carbon | Metal | Hydrogen storage |
|---|---|---|---|
| Example | composite | content (wt %) | amount (wt %) |
| 8 | Fe | 21 | 0.4 |
| 9 | Ir | 5 | 0.6 |
| 10 | Rh | 8 | 0.7 |
| 11 | Ag | 11 | 0.3 |
| 12 | Au | 7 | 0.8 |
| 13 | Os | 2 | 1.1 |
| 14 | Cr | 20 | 0.9 |
| 15 | Mo | 31 | 0.7 |
| 16 | V | 22 | 0.1 |
| 17 | Ta | 4 | 0.2 |
| 18 | Zr | 8 | 0.5 |
| 19 | Hf | 3 | 0.1 |
| 20 | Li | 4 | 1.5 |
| 21 | Na | 3 | 1.3 |
| 22 | K | 5 | 1.2 |
| 23 | Be | 31 | 0.4 |
| 24 | Ca | 27 | 0.2 |
| 25 | Ba | 32 | 0.1 |
| 26 | Mn | 10 | 0.6 |
| 27 | Pd | 41 | 1.2 |
| 28 | Ti | 39 | 1.0 |
| 29 | Zn | 21 | 0.2 |
| 30 | Al | 16 | 0.5 |
| 31 | Ga | 22 | 0.4 |
| 32 | Sn | 22 | 0.1 |
| 33 | Pb | 31 | 0.3 |
| 34 | Sb | 13 | 0.5 |
| 35 | Se | 21 | 0.3 |
| 36 | Te | 18 | 0.6 |
| 37 | Cs | 22 | 0.5 |
| 38 | Rb | 5 | 0.4 |
| 39 | Sr | 15 | 0.2 |
| 40 | Ce | 21 | 0.4 |
| 41 | Pr | 9 | 0.8 |
| 42 | Nd | 5 | 0.5 |
| 43 | Sm | 13 | 0.6 |
| 44 | Re | 5 | 1.0 |
| 45 | B | 31 | 1.2 |

While the invention is susceptible to various modifications and alternative forms, specific embodiments have been shown by way of example in the drawings and described in detail herein. However, it should be understood that the invention is not limited to the particular forms disclosed. Rather, the invention covers all modifications, equivalents, and alternatives falling within the spirit and scope of the invention as defined in the appended claims.

### INDUSTRIAL APPLICABILITY

As discussed earlier, a nano-structured metal-carbon composite and a process for preparation thereof according to an embodiment of the present invention improve the hydrogen storage efficiency and the hydrogen storage capacity. Accordingly, the composite and the method are applied to various fields of storing and using hydrogen which is clean energy, and particularly used in hydrogen fuel storage and hydrogen supply materials of fuel cell automobiles on which extensive studies have been currently made, thereby providing a remarkable solution on exhaustion of energy resources and pollution due to usage of fossil fuel. Furthermore, the disclosed composite may be used in electronic materials and various catalyst reactions depending on kinds of used metals.

In addition, according to the nano-structured metal-carbon composite and the process for preparation thereof, since a metal precursor and a carbon precursor are both impregnated in a nano template, the composite can be fabricated without additionally changing apparatus. Therefore, the disclosed process is simpler and more economical than the conventional process for preparing a carbon nano-tube.

1. A nano-structured metal-carbon composite prepared using a nano template.

2. The nano-structured metal-carbon composite according to claim 1, wherein the nano template is selected from silica oxide, alumina oxide or mixtures thereof.

3. The nano-structured metal-carbon composite according to claim 2, wherein the nano template is a silica oxide.

4. The nano-structured metal-carbon composite according to claim 1, wherein a carbon precursor of the metal-carbon composite is selected from the group consisting of furfuryl alcohol, glucose and sucrose.

5. The nano-structured metal-carbon composite according to claim 4, wherein the carbon precursor is sucrose.

6. The nano-structured metal-carbon composite according to claim 1, wherein the metal-carbon composite comprises at least one metal selected from the group consisting of Pt, Ru, Cu, Ni, Mg, Co, W, Fe, Ir, Rh, Ag, Au, Os, Cr, Mo, V, Ta, Zr, Hf, Li, Na, K, Be, Ca, Ba, Mn, Pd, Ti, Zn, Al, Ga, Sn, Pb, Sb, Se, Te, Cs, Rb, Sr, Ce, Pr, Nd, Sm, Re and B.

7. The nano-structured metal-carbon composite according to claim 6, wherein the metal precursor is selected from (NH₃)₄Pt(NO₃)₂, (NH₃)₆RuCl₃, CUCl₂, Ni(NO₃)₂, Mg(NO₃)₂, CoCl₂, (NH₄)₆W₁₂O₃₉, FeCl₃ or FeCl₃(NH₄)₃, IrCl₆, RhCl₃, AgCl, NH₄AuCl₄, OsCl₃, CrCl₂, MoCl₅, VCl₃, TaCl₅, ZrCl₄, HfCl₄, Li₂CO₃, NaCl, KCl, Be(CH₃COCHCOCH₃)₂, CaCl₂, BaCl₂, MnCl₂, Pd(NO₃)₂, TiCl₄, ZnCl₂, AlCl₃, Ga₂Cl₄, SnCl₄, PbCl₂, SbCl₃, SeCl₄, TeCl₄, CsCl, RbCl, SrCl₂, CeCl₃, PrCl₃, NdCl₃, SmCl₃, ReCl₃ and BCl₃.

8. The nano-structured metal-carbon composite according to claim 1, wherein the metal is contained in an amount ranging from 1 to 95 wt % and the carbon is contained in an amount ranging from 5 to 99 wt %, based on the gross weight of the metal-carbon composite.

9. The nano-structured metal-carbon composite according to claim 8, wherein the metal is contained in an amount ranging from 4 to 36 wt % and the carbon is contained in an amount ranging from 64 to 96 wt %, based on the gross weight of the metal-carbon composite.

10. The nano-structured metal-carbon composite according to claim 6, wherein the platinum is contained in an amount ranging from 0.2 to 44 wt % and the carbon is contained in an amount ranging from 56 to 99.8 wt %, based on the gross weight of the metal-carbon composite.

11. The nano-structured metal-carbon composite according to claim 10, wherein the platinum is contained in an amount ranging from 2 to 34 wt % and the carbon is contained in an amount ranging from 66 to 98 wt %, based on the gross weight of the metal-carbon composite.

12. A process for preparing a nano-structured metal-carbon composite, comprising:
the preparation step of preparing a nano template;
the calcination step of calcining the prepared nano template;
the impregnation step of impregnating a metal into the calcined nano template using a metal precursor;
the addition and mixing step of adding a carbon precursor in the nano template impregnated with the metal and mixing the carbon precursor uniformly;
the reaction step of reacting the resultant mixture prepared in the addition and mixing step;
the carbonization step of carbonizing the resultant reacted mixture; and
the removal step of removing the nano template from the resultant carbonized mixture.

13. The method according to claim 12, wherein the nano template is selected from silica oxide, alumina oxide or mixtures thereof

14. The method according to claim 13, wherein the nano template is a silica oxide.

15. The method according to claim 12, wherein the reaction step is performed at a temperature ranging from 100 to 160° C., and the carbonization step is performed at a temperature ranging from 800 to 1000° C.

16. The method according to claim 12, wherein the carbon precursor is selected from the group consisting of furfuryl alcohol, glucose and sucrose.

17. The method according to claim 16, wherein the carbon precursor is sucrose.

18. The method according to claim 12, wherein the metal-carbon composite comprises at least one metal selected from the group consisting of Pt, Ru, Cu, Ni, Mg, Co, W, Fe, Ir, Rh, Ag, Au, Os, Cr, Mo, V, Ta, Zr, Hf, Li, Na, K, Be, Ca, Ba, Mn, Pd, Ti, Zn, Al, Ga, Sn, Pb, Sb, Se, Te, Cs, Rb, Sr, Ce, Pr, Nd, Sm, Re and B.

19. The method according to claim 18, wherein the metal precursor is selected from (NH₃)₄Pt(NO₃)₂, (NH₃)₆RuCl₃, CuCl₂, Ni(NO₃)₂, Mg(NO₃)₂, CoCl₂, (NH₄)₆W₁₂O₃₉, FeCl₃ or FeCl₃(NH₄)₃, IrCl₆, RhCl₃, AgCl, NH₄AuCl₄, OsCl₃, CrCl₂, MoCl₅, VCl₃, TaCl₅, ZrCl₄, HfCl₄, Li₂CO₃, NaCl, KCl, Be(CH₃COCHCOCH₃)₂, CaCl₂, BaCl₂, MnCl₂, Pd(NO₃)₂, TiCl₄, ZnCl₂, AlCl₃, Ga₂Cl₄, SnCl₄, PbCl₂, SbCl₃, SeCl₄, TeCl₄, CsCl, RbCl, SrCl₂, CeCl₃, PrCl₃, NdCl₃, SmCl₃, ReCl₃ and BCl₃.

20. The nano-structured metal-carbon composite according to claim 7, wherein the platinum is contained in an amount ranging from 0.2 to 44 wt % and the carbon is contained in an amount ranging from 56 to 99.8 wt %, based on the gross weight of the metal-carbon composite.
